(19) United States
(12) Patent Application Publication
(10) Pub. No.: US 2020/0076350 A1
(43) Pub. Date: Mar. 5, 2020

(54) POWER GENERATION CUBE

(71) Applicant: George Uh-Schu LIAU, Markham (CA)

(72) Inventor: George Uh-Schu LIAU, Markham (CA)

(21) Appl. No.: 16/120,653

(22) Filed: Sep. 4, 2018

(51) Int. Cl. H02S 10/40; H02S 10/10; H02S 30/10; H02S 40/22; H02S 99/00

(52) U.S. Cl. CPC H02S 10/40; H02S 10/10; H02N 11/008; H02S 40/22; H02S 99/00; H02S 30/10

(57) ABSTRACT

A cube for generating power comprising: a plurality of unit cubes each having twenty four solar cells formed into six pyramids for collecting light power are installed inside the cube; wherein a crystal ball is installed inside each of said unit cube, the panels for forming said unit cube are solar cells enable to collect energy and transfer it into electricity, and a light reflecting means is formed onto the base of said pyramid inside the unit cube; a plurality of light emitting elements are formed around said light reflecting means, each side of the pyramid is tapered to the center of unit cube; as such, by the application of small amount of electric power, ultra violet (UV) light is emitted from the light emitting elements (LED), the interaction of photons from UV light and electrons of said crystal balls inside all unit cubes started, then power is generated and collected for people's utilizations.

### BACKGROUND OF THE INVENTION

### Field of the Invention

The present invention relates to a cube, in particular to a cube having a plurality of unit cubes each consists of six pyramids without apexes, so that the unit cube has six sides of bases is formed, and after the ignition of light emitting elements inside the unit cube, UV lights is generated to cause interaction between photons and electronics so as to generate power.

### Description of the Related Art

At present, the commonly used equipments, such as mechanical equipment, electronic equipment or electrical equipment, need to be driven by electric power. In addition to the power supply equipment using AC power, the power source is mainly convenient to use battery power, although the battery has the advantages of being light and easy to carry. However, there is a problem that it cannot be charged by itself.

The general power generation equipment can also use wind power, hydraulic power or solar energy to generate electricity, but through wind power, hydraulic power to convert mechanical energy into electricity or use solar panels to convert solar energy from sun light into electrical energy, due to its large volume, shall cause the problems of occupying a large space and equipment weight, the maintenance is then difficult to perform, thus can not meet the needs of public.

### SUMMARY OF THE INVENTION

Accordingly, the present invention is directed to providing a portable power generation unit that can be powered by ultraviolet light due to the ignition of light emitting element (LED), thus the cost for power generation is greatly down, this is an object of present invention.

The power generation of the present invention is provided with a plurality of unit cubes, each unit cube consists of six pyramids without apexes, the bases of pyramids then become the sides of the unit cube, then it is convenient for transportation and storage, this is an another object of present invention.

According to the power generation cube of the present invention, a light reflecting mirror is installed onto the base of each pyramid inside the unit cube, and light emitting elements for emitting UV light are formed around said mirror so that the six identical pyramids of unit cube can generate electricity due to interactions of protons from UV light and electrons generated by the crystal ball respectively. This is another object of the present invention.

According to the power generation cube of the present invention, it further includes a plurality of energy collecting means to form the plurality of unit cubes, wherein the energy collecting means is disposed inside each unit cube to form the pyramid, and each side of the pyramid is tapered toward the center of the unit cube. When the light emitting element (LED lamp) emits ultraviolet (UV) light, the collected ultraviolet light beam is directed to the central crystal ball, and then guided to interior portion of each pyramid, and is reflected from the interior portion of the pyramid to the inner surface of the tapered panels of solar cells to generate electricity by solar cells. This is a further object of the present invention.

According to the power generation cube of present invention, the unit cube may have openings on corners of the unit cube to let UV light emitted from light emitting element (LED) and go out to other unit cubes, then interactions of protons and electrodes generated in every unit cube, this is a further object of present invention.

According to the power generation cube of present invention, the outside surface of the whole cube is covered or sealed, such that the light generated inside the cube can be kept, this is a further object of the present invention.

The detailed structure, application principles, functions and effectiveness of the present invention will be apparent with reference to the following description in conjunction with the accompanying drawings.

### BRIEF DESCRIPTION OF THE DRAWINGS

FIG. 1 is a diagram showing an example of power generation cube of the present invention.

FIG. 2 is a diagram showing another example of power generation cube of the present invention.

FIG. 3 is a perspective view of the unit cube of the present invention.

FIG. 4 is a plan view of the single pyramid inside the unit cube of the present invention.

FIG. 5 is a view showing an embodiment of the light emitting elements and light reflecting mirror of the present invention.

FIG. 6 is a diagram showing the interaction between photons (p) from UV lamps and electrons (1) from crystal ball occurred to generate photo energy.

### DETAILED DESCRIPTION OF PREFERRED EMBODIMENT

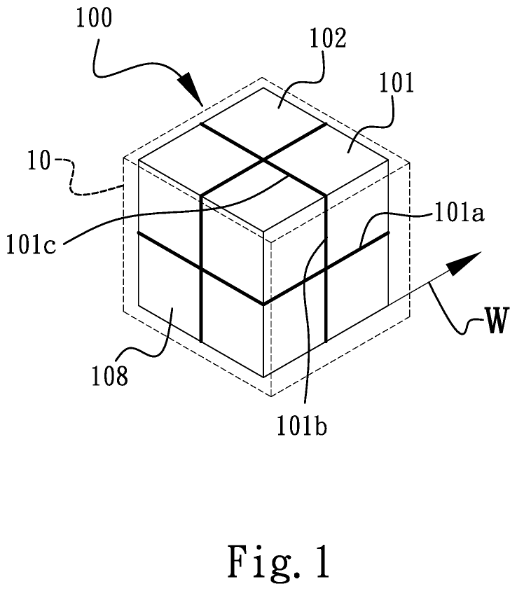

As shown in FIGS. 1 & 2, the power generation cube 100, 200 of the present invention is provided with a plurality of unit cubes 101, 102, . . . , 108; 201, 202, . . . , 227, inside a sealed housing 10, 20. The number of unit cubes forming the power generation cube is preferably a cube of integer, for example, eight unit cubes (2×2×2=8), or twenty seven unit cubes (3×3×3=27), and so on.

The overall size of the whole cube shall be limited to be able carried around. A housing 10, 20 can be used as a container or holder of subject power generation cube.

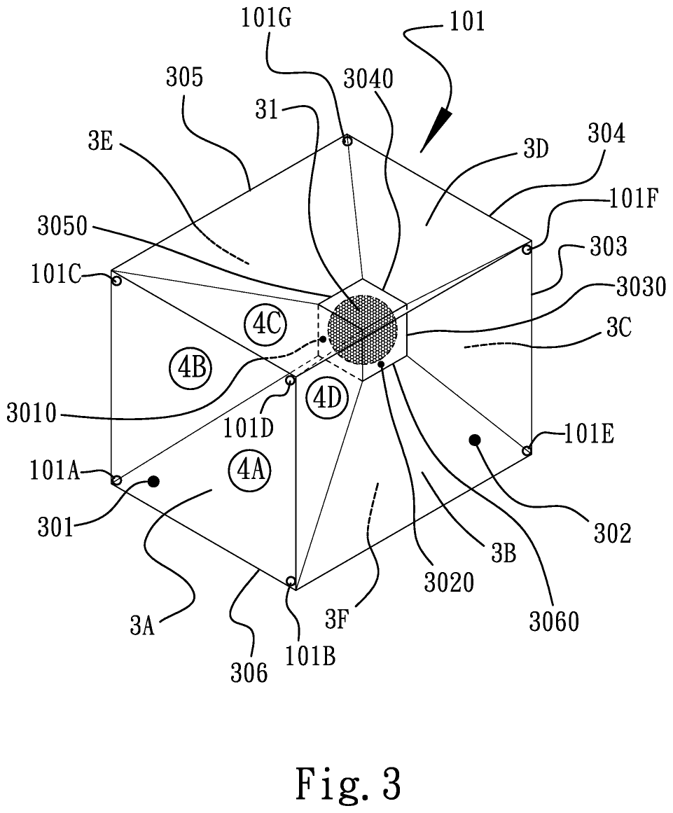

Referring to FIG. 3, it is seen that the single unit cube consists of six pyramids 3A, 3B, 3C, 3D, 3E, 3F without apexes, but with bases as six sides 301, 302, 303, 304, 305, 306 of the unit cube.

There is a crystal ball 31 made of laser crystal such as garnet/sapphire/vanadate/fluorides/tungstates etc. in the center of the unit cube, held by and set on the top openings 3010, 3020, 3030, 3040, 3050, 3060 of six pyramids 3A, 3B, 3C, 3D, 3E, 3F. The crystal ball can be replaced by other materials of gain media.

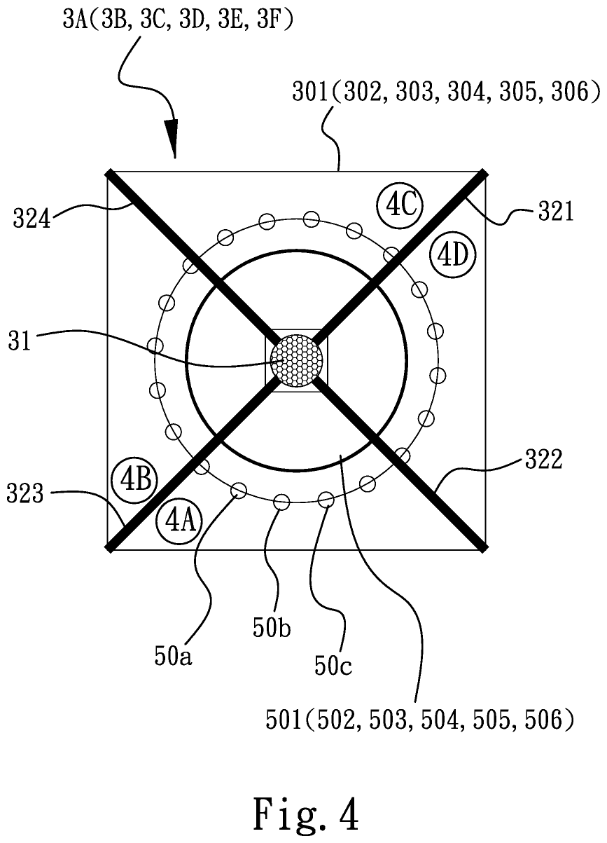

As shown in FIG. 3 and FIG. 4, each pyramid has four sides 4A, 4B, 4C, 4D respectively made of a plurality of panels of solar cells. Four identical solar cells panels from four base-lines of the pyramid to the crystal ball in the center of the unit cube form four adjacent walls/partitions 321, 322, 323, 324 each between two pyramids.

As shown in FIG. 3 & FIG. 4, on the inside surface of the pyramid base (301,302, 303, 304, 305, 306) there is a round mirror (501,502, 503, 504, 505, 506) in the center and several UV (ultraviolet) light emitting elements 50a, 50b, 50c . . . . Such as LEDs (light-emitting diodes) around the mirror, wherein Micro LED is preferred.

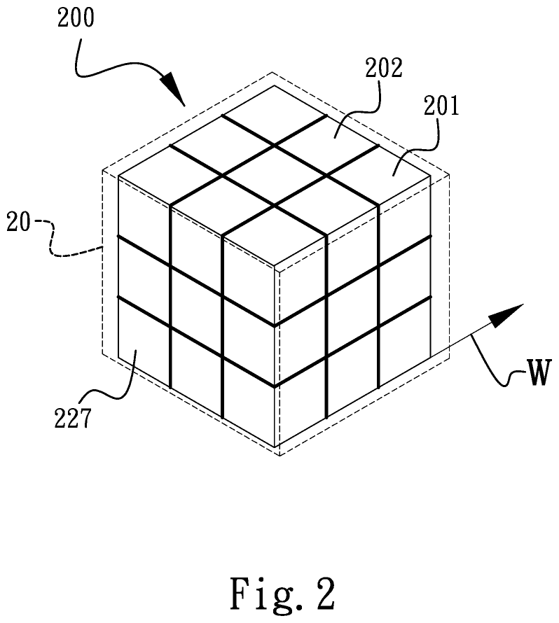

As shown in FIG. 1 & FIG. 2 again, a strong industrial glue is used to bond all the parts in place, and is reinforced by an outside edge frame 101a, 101b, 101c . . . on each joint base line of the whole cube.

As shown in FIG. 4 again, an initial power source such as a battery is used for UV light emitting elements 501a, 501b, 501c, . . . to get started. Here a battery can be used to serve just like a lighter. Once UV LED is on, electricity generated by the cube will be partially directed to UV LEDs. So the cube can self-sustain its own electric supply.

UV light from six sides of light emitting elements 501a, 501b, 501c, . . . of each unit cube shine on the central crystal ball 31 to cause interaction of photons and electrons started. Further more, the generated UV light is reflected from each mirror 501(502, 503, 504, 505, 506) back to the central crystal ball 31, that further strengthening the interaction of photons and electrons of the central crystal ball 31 and UV light is bouncing back and forth between the central crystal ball 31 and said six mirrors 501, 502, 503, 504, 505, 506, and the interaction of photons and electrons of the central crystal ball 31 getting intensified as that happens in a laser. UV light is then magnified inside the unit cube 101, 102, . . . .

The magnified UV light shine on solar cells panels forming pyramids 3A, 3B, 3C, 3D, 3E, 3F inside the unit cube 101, 102, . . . 108, . . . and electricity is generated to be output via electric wire W (as shown in FIG. 1 & FIG. 2) for people's utilizations.

As shown in FIG. 3, the unit cube 101(102, 103, . . . 108), . . . may have openings 101A, 101B, 101C, 101D, 101E, 101F, 101G, 101H, on cube corners to let UV light go out from one unit cube to other unit cubes.

Corner openings of every adjacent unit cube inside the whole cube are connected to each other. Outside surface or housing 10, 20 of the whole cube ½ is covered or sealed to keep light inside.

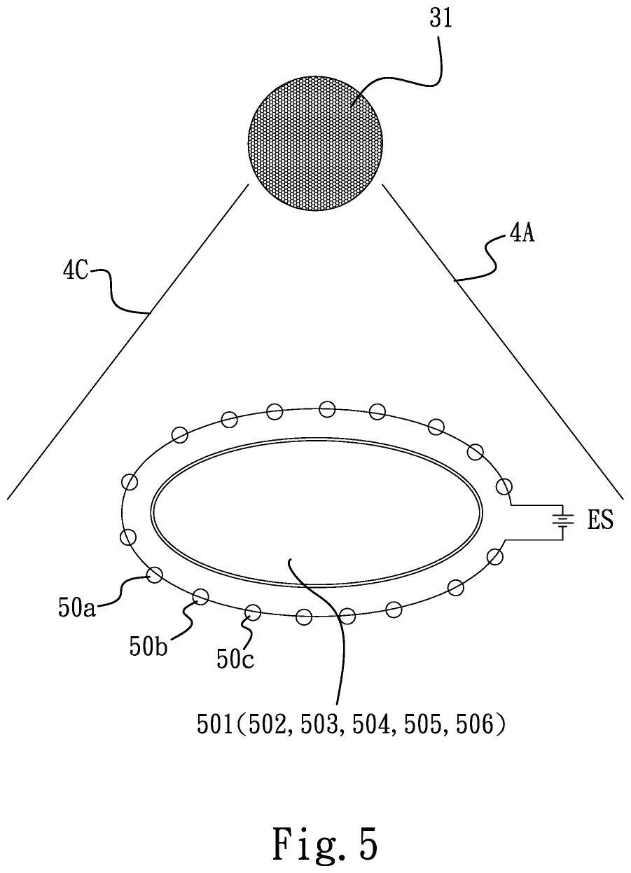

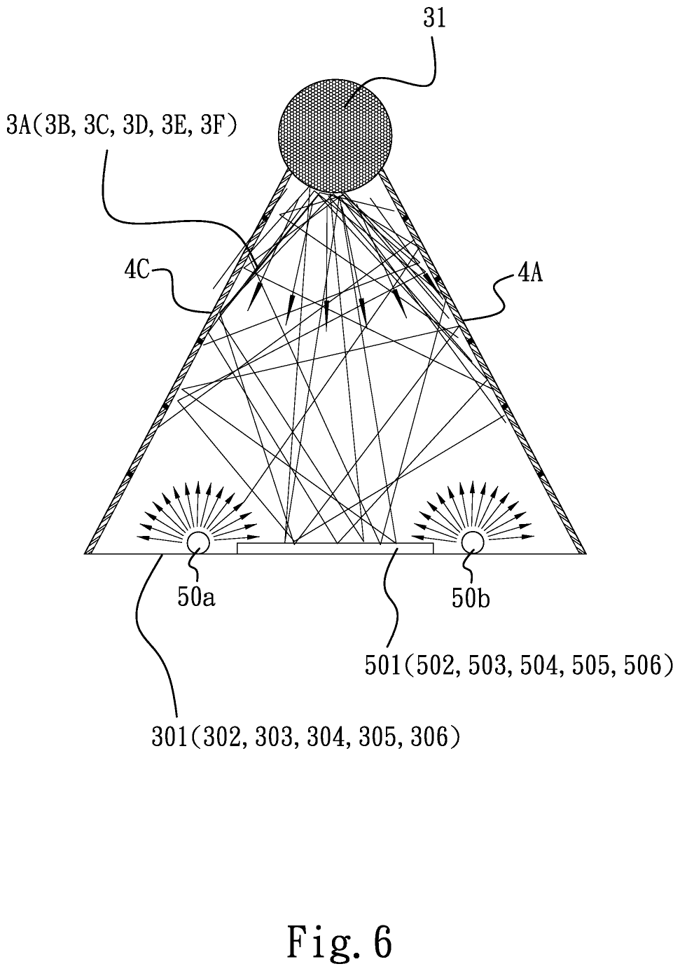

Please refer to FIGS. 1-6, UV light from only one unit cube 101, 102, 103, . . . 108 can access all other unit cubes of the whole cube ½ via openings 101A, 101B, 101C, 101D, 101E, 101F, 101G, 101H, on corners of every unit cube, in order to start the interaction of photons and electrons of the central crystal balls 31 inside all other unit cubes 101, 102, . . . of the whole cube ½. That means a great amount of energy is saved in power input, after the use to maintain the UV lightening of the LED of one unit cube. And net power output can increase with increased total number of unit cubes 101, 102, . . . , 108 of the whole cube ½. Electric wire W is directed along edges or joint base lines of each unit cube 101, 102, . . . , 1088 and then covered by a housing 10 of thin rubber membrane etc.

In summary from above, the power generation cube of the present invention is constructed as an unprecedented innovation, which is neither found in any publication, nor is there any similar product on the market, so that its novelty should be undoubted. In addition, the unique features and functions of the present invention are far from comparable to the conventional power generators, so it is indeed more progressive than the conventional ones, and the patent application is in accordance with the provisions of the application requirements of the invention patents of the U.S. Patent Laws.

It should be understood that the exemplary embodiments described therein should be considered in a descriptive sense only and not for purposes of limitation. Descriptions of features or aspects within each embodiment should typically be considered as available for other similar features or aspects in other embodiments.

Although specific embodiments of the present invention have been described for illustrative purposes, those skilled in the art will appreciate that various modifications, additions and substitutions are possible, without departing from the scope and the spirit of the invention as disclosed in the accompanying claims.

What is claimed is:

1. A power generation cube having a plurality of unit cubes, each unit cube consists of six pyramids without apexes, the bases of pyramids then become the sides of the unit cube, wherein a light reflecting mirror is installed onto the base of each pyramids inside the unit cube, and light emitting elements for emitting UV light are formed around said mirror so that the six identical pyramids of unit cube can generate electricity due to interactions of photons from UV light and electrons generated by the crystal ball installed at center of unit cube.

2. The power generation cube according to claim 1, wherein the pyramid is formed by a plurality of light collecting means as four sides of the pyramid, and is tapered toward the center of the unit cube for a crystal ball to put on tops of said six pyramids.

3. The power generation cube according to claim 1, wherein on the inside surface of the pyramid base there is a round mirror in the center and a plurality of UV (ultraviolet) LEDs (light-emitting diodes) formed around the mirror, wherein Micro LED is preferred.

4. The power generation cube according to claim 1, wherein said LED lamp emits ultraviolet (UV) light, the ultraviolet light beam is directed and reflected by said mirror to the central crystal ball, and then guided to interior portion of each pyramid to cause interactions between photons of UV light and electrons from the crystal ball, and light from the interior portion of the pyramid shine onto the inner surface of the tapered panels of solar cells to generate electricity by solar cells.

5. The power generation cube according to claim 1, wherein the unit cube may have openings on corners of the unit cube to let UV light emitted from light emitting element (LED) go out to other unit cubes, then interactions of photons and electrons can take place to generate photo energy in other unit cubes.

6. The power generation cube according to claim 1, wherein the outside surface of the whole cube is covered or sealed, such that the light generated inside the cube can be kept.

7. The power generation cube according to claim 1, wherein the number of unit cubes contained in the cube is a cube of integer, such as eight (2×2×2=8), or twenty seven (3×3×3=27), and etc.

8. The power generation cube according to claim 2, wherein said crystal ball made of laser crystal such as garnet/sapphire/vanadate/fluorides/tungstates/or other gain media is put in the center of the unit cube, held by and set on top openings of six pyramids of the unit cube.

9. The power generation cube according to claim 1, wherein a strong industrial glue is used to bond all the parts in place, and is reinforced by an outside edge frame on each joint base line of the whole cube.

10. The power generation cube according to claim 5, wherein the corner openings of every unit cube inside the whole cube are connected to other unit cube corner openings.
